(19) United States
(12) Patent Application Publication
(10) Pub. No.: US 2013/0262291 A1
(43) Pub. Date: Oct. 3, 2013

(54) UNIVERSAL CREDIT CARD

(71) Applicant: FLEXTRONICS AP, LLC, San Jose, CA (US)

(72) Inventor: Christopher P. RICCI, Saratoga, CA (US)

(21) Appl. No.: 13/834,819

(22) Filed: Mar. 15, 2013

Related U.S. Application Data
(60) Provisional application No. 61/611,238, filed on Mar. 15, 2012.

(51) Int. Cl. G06Q 20/22

(52) U.S. Cl. CPC G06Q 20/227
USPC 705/38; 705/39

(57) ABSTRACT

A method, system and program for providing financing to a user from one or more finance sources are disclosed. Each finance source has financing data associated with that finance source. Purchase information reflecting a purchase transaction including a monetary amount of the purchase transaction is received. One or more of the finance sources are selected using at least a portion of the respective financing data to make the selection. A financing-request transaction is initiated with the one or more selected finance sources on behalf of the user to obtain financing for the user to complete the purchase transaction. A method for selecting a resource is also disclosed. An abstract definition of a resource is received. The abstract definition of the resource is converted into one or more search requests that fall within the abstract definition. The one or more search requests is run against a data repository to produce descriptions of resources. The descriptions of resources are provided. Financing to purchase the selected resource may then be provided.

### CROSS REFERENCE TO RELATED APPLICATION

The present application claims the benefits of U.S. Provisional Application Ser. No. 61/611,238, filed Mar. 15, 2012, entitled “Universal Card”, which is incorporated herein by this reference in its entirety.

### FIELD

The disclosure relates generally to credit transactions and particularly to credit card transactions.

### BACKGROUND

Credit cards and debit cards are ubiquitous. Almost every financial institution, major retailer, fuel company, etc., offers one. With these thousands of different offerings, the card suppliers compete using a complex combination of interest rates (introductory, cash, purchases, etc.), rewards programs (points, airline miles, cash back, etc.), fees (annual fees, late fees, transfer fees, etc.), and many others. Further, there are generally time factors built into these cards. For example, introductory fees expire after a set period of time, then automatically go up to a set rate; “same as cash” credit cards usually offered by retailers offer low interest for a set period, but if not paid by the end of that period, all of the past interest becomes due; still others require full payment at the end of each month. Finally, with credit card offers coming in every day's mail, most consumers have multiple cards.

With multiple cards, each having multiple features, it becomes difficult for the consumer to judge which card or cards provide the feature or features that they wish for a particular transaction.

### SUMMARY

These and other needs are addressed by the various aspects, embodiments, and/or configurations of the present disclosure. The present disclosure is directed to an automated transaction assistant to analyze a proposed purchase transaction and provide a transaction structure providing an optimal or near optimal set of benefits to a purchaser.

The disclosure can provide a method for providing financing to a user from one or more finance sources. Each finance source has financing data associated with that finance source. The method includes receiving purchase information reflecting a purchase transaction including a monetary amount of the purchase transaction, selecting one or more of the finance sources using at least a portion of the respective financing data to make the selection, and initiating a financing-request transaction with the one or more selected finance sources on behalf of the user to obtain financing for the user to complete the purchase transaction.

The method may include receiving credit data regarding the user from a credit reporting agency, populating a profile with the credit data, and storing the credit data in a database.

The method may include accepting modifications or additions to the credit data on the profile.

The method may include accepting an assignment of a preference for one of the finance sources.

The method may include accepting loyalty program data associated with one of the finance sources.

The method may include accepting approval of the financing-request transaction from the one or more selected finance sources and sending approval of the purchase transaction associated with the finance sources.

The method may include billing the user for the purchase transaction; accepting payment from the user; and sending payment to the one or more selected finance sources, with terms of the payment taking into account the financing data for the user's finance sources.

The method may include receiving from one of the one or more finance sources a change in the financing data associated with the provision of financing by that finance source; adopting the change for use in selecting the one or more finance sources having, collectively, the financing data most advantageous to the user for the purchase transaction; and using the revised financing data to consider a redistribution of financing among the finance sources. Initiating the financing-request transaction with the one or more selected finance sources on behalf of the user to request financing for the user to complete the purchase transaction may include requesting financing for less than the monetary amount of the purchase transaction.

The disclosure can provide a system for providing financing to a user from one or more finance sources. Each finance source has financial data associated with the provision of financing by that finance source. The system includes a finance source database containing data regarding the one or more finance sources available to a user. The system also includes a transaction assistant capable of receiving purchase information reflecting a purchase transaction including a monetary amount of the purchase transaction, using the data stored in the finance source database to select one or more finance sources using at least a portion of the respective finance information to make the selection, and initiating a financing-request transaction with the one or more selected finance sources on behalf of the user to obtain financing for the user to complete the purchase transaction.

The system may include a web site capable of receiving financing data and storing the financing data in the finance source database. The web site may be further capable of accepting additions and/or modifications to the financing data from the user.

The transaction assistant can receive data regarding the use of the finance sources and store the data regarding the use of the finance sources in the finance source database.

The transaction assistant can issue a universal card to the user if the financing data for the user stored in the finance source database warrants issuing the universal card.

The transaction assistant can accept approval of the financing-request transaction from the selected finance source and send approval of the purchase transaction associated with the finance source.

The transaction assistant can bill the user for the purchase transaction; accept payment from the user; and send payment to the one or more selected finance sources, with terms of the payment taking into account the finance data for the user's finance sources.

The transaction assistant access the user's bank in order to send payment to the one or more selected finance sources.

The transaction assistant can receive from one of the one or more finance sources a change in the finance data associated with the provision of credit by that finance source, save the change in finance data in the finance source database, and use the revised finance data in the finance source database to consider a redistribution of financing among the finance sources.

The disclosure can provide a computer program, stored on a non-transient, tangible storage medium, for use in providing financing to a user from one or more finance sources. Each finance source has financing data associated with that finance source. The computer program includes executable instructions that cause a computer to receive purchase information reflecting a purchase transaction including a monetary amount of the purchase transaction, select one or more of the finance sources using at least a portion of the respective financing data to make the selection, and initiate a financing-request transaction with the one or more selected finance sources on behalf of the user to obtain financing for the user to complete the purchase transaction.

The disclosure can provide a method for selecting a resource including receiving an abstract definition of a resource, converting the abstract definition of the resource into one or more search requests that fall within the abstract definition, running the one or more search requests against a data repository to produce descriptions of resources, and providing the descriptions of resources.

The data repository may be the Internet.

The method may include providing an analysis of the described resources.

Converting the abstract definition of the resource into one or more search requests that fall within the abstract definition may include directing the search requests to one or more vendors listed in a profile.

The present disclosure can provide a number of advantages depending on the particular aspect, embodiment, and/or configuration. By way of illustration, the transaction assistant can determine credit risk and distribute higher risk accounts to other creditors. It can be a minor credit player or a large one, purely at its discretion and with an ability to vary this decision virtually on its whim. It can, in exchange for its services, receive transaction and interest income. It can provide a user of the card automatically with an optimal or near optimal transaction structure comparatively providing the user with the best package of credit terms and/or benefits available to them. The risk of being rejected at the time of a purchase can be minimized. It can present better credit deals to the user electronically based upon what he or she currently has available, and the assistant's determination that better deals exist.

These and other advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “credit card issuer” as used herein refers to a bank, credit union, or business that offers or issues a credit card. The credit card issuer makes the credit limit available to cardholders and is responsible for sending payments to merchants for purchases made with credit cards from that bank. Credit card issuers often need the help of payment processing networks, like Visa and MasterCard.

The term “credit card” or “charge card” as used herein refers to a card issued by a credit card issuer giving the holder an option to borrow funds, usually at point of sale. Credit cards can take many forms. They can be a plastic card having a readable strip, particularly a magnetic strip. They can be a smart card. They can be an electronic virtual card, which is stored on a computational device such as a personal digital assistant, cell phone, notebook computer, tablet computer, and the like. In such devices, the credit card information can be transmitted wirelessly, such as by scanning or wireless transmission, to a vendor's computational device to effect a transaction. Credit cards charge interest and are primarily used for short-term financing. Interest usually begins one month after a purchase is made and borrowing limits are pre-set according to the individual's credit rating.

The term “credit reporting agency” as used herein refers to a credit bureau and/or credit reference agency that collects information from various sources and provides consumer credit information on individual consumers for a variety of uses. The credit information describes the individuals' borrowing and bill-paying habits. Credit information can include for example, credit card identification information (e.g., credit card number, credit line, expiration date, authorization code, credit card issuer, and the like), loan identification information (e.g., loan, line-of-credit, or other credit-related number, credit line amount, credit terms, such as expiration date or repayment term, payment terms, interest rate and other terms of outstanding loans or credit, and the like), credit issuer or lender, interest rate and other terms of outstanding loans or credit, and the like), a person's previous loan payment performance (e.g., current outstanding balance, instances of timely and/or late payments, amount paid to date, and the like), credit worthiness indicators such as credit rating, description of court adjudicated debt obligations like tax liens or bankruptcies, and other personal and financial information. In the U.S., credit bureaus collect and aggregate personal information, financial data, and alternative data on individuals from a variety of sources called data furnishers with which the bureaus have a relationship. Data furnishers are typically creditors, lenders, utilities, debt collection agencies and the courts (i.e., public records) that a consumer has had a relationship or experience with. Data furnishers report their payment experience with the consumer to the credit bureaus. The data provided by the furnishers as well as collected by the bureaus are then aggregated into the credit bureau's data repository or files. The resulting information is made available on request to customers of the credit bureau for the purposes of credit risk assessment, credit scoring or for other purposes.

A “database” as used herein refers to an organized set of data held in a computer. The organization schema or model for the data can, for example, be hierarchical, network, relational, entity-relationship, object, document, XML, entity-attribute-value model, star schema, object-relational, associative, multidimensional, multivalue, semantic, and other database designs.

The term “debit card” as used herein refers to an electronic card issued by a bank, which allows bank clients access to their account to withdraw cash or pay for goods and services.

The terms “determine”, “calculate” and “compute,” and variations thereof, as used herein, are used interchangeably and include any type of methodology, process, mathematical operation or technique.

The term “electronic address” refers to any contactable address, including a telephone number, instant message handle, e-mail address, Universal Resource Locator (“URL”), Universal Resource Identifier (“URI”), Address of Record (“AOR”), electronic alias in a database, like addresses, and combinations thereof.

The terms “instant message” and “instant messaging” refer to a form of real-time text communication between two or more people, typically based on typed text.

The term “internet search engine” refers to a web search engine designed to search for information on the World Wide Web and FTP servers. The search results are generally presented in a list of results often referred to as SERPS, or “search engine results pages”. The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™, store every word of every page they find.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

A “product” as used herein refers to a good, article, idea, method, information, object, and/or service created as a result of or involving a process or method and serves a need and/or desire of a purchaser.

The term “smart card” as used herein refers to a card, typically plastic, embedded with a computer readable medium, such as a memory chip, and, optionally, a microprocessor and/or power source. The computer readable medium can be loaded with data, used for telephone calling, electronic cash payments, and other applications, and then periodically refreshed for additional use. A smart card can contain more information than a magnetic stripe card and can be programmed for different applications. Some cards can contain programming and data to support multiple applications and some can be updated to add new applications after they are issued. Smart cards can be designed to be inserted into a slot and read by a special reader or to be read at a distance, such as at a toll booth. Cards can be disposable or reloadable.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram of a system for processing transactions using a universal card.

FIG. 2 is a flow chart describing the processing associated with the issuance of a universal card.

FIG. 3 is a flow chart describing the processing associated with the use of a universal card.

FIG. 4 is a flow chart describing the processing associated with payments associated with the use of a universal card.

FIG. 5 is a flow chart describing the processing associated with accepting changes to the contractual relationship with finance sources.

FIG. 6 is a flow chart describing selecting a resource to purchase and processing the purchase transaction using a universal card.

FIG. 7 is a flow chart describing providing a user with recommendations as to a transaction structure.

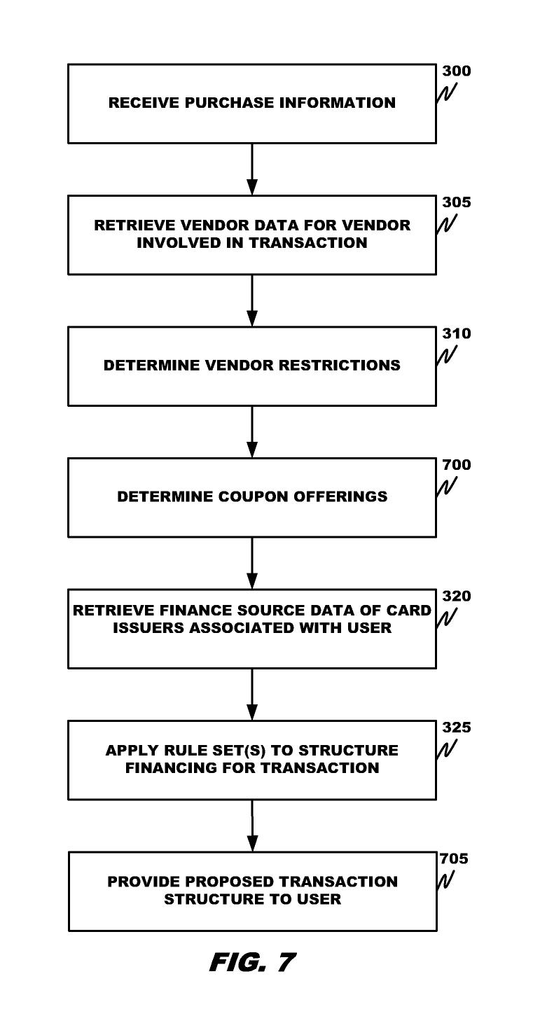

### DETAILED DESCRIPTION

### Overview

A transaction system that can provide a solution to the problem identified above provides the ability for a company, financial or otherwise, to issue a “universal” card (“universal” indicating that that use of the card may be distributed across a range of options in equal amounts, or that the card presents multiple options). The card would likely be configured to use a standard network, such as the VISANET®, the network used by many credit cards including Visa, although such a network is not a requirement.

The card is used just like any other credit or debit card. However, instead of the user's transaction being made against one specific finance source, such as a credit card, the transaction can be made against any of a user's finance sources. These finance sources can be have a variety types, such as credit cards that allow credit transfers, credit cards which the universal card can place the retail transaction as a simple retail transaction, revolving credit lines, secured loans, finance sources that are established by the universal card company itself, inter alia. As used here, the term “financing” should be interpreted broadly, to not only include credit, which is an arrangement by which a buyer can take possession of something now and pay for it later or over time, but also include a debit, where a sum of money is removed from the buyer's account in payment for something. For example, a bank account could be established as a finance source, where instead of placing the credit into a standard credit source, cash is withdrawn and the universal card acts as a debit card. Further, a finance source could include other cards that may otherwise be considered credit or charge cards. The finance source then is an account provided by a person or entity which will provide funds for the purchase transaction. For example, if the user has two VISA® cards, a MASTERCARD, and a universal card as described herein, use of the universal card in a transaction may cause a charge to be made against any of the three other credit cards, depending on which provides the best terms for that transaction. Further, the universal card may be used to access other sources of credit available to the user, such as a revolving line of credit or a credit secured by, for example, a security interest. Indeed, the universal card may spread the transaction across a number of finance sources to achieve the best possible terms for the user for that transaction.

### The Transaction System 100

The transaction system 100 is typically configured as a distributed processing network. It can include a user's bank 125 associated with a user 120, a credit reporting agency 105, one or more search engines 150, a vendor 154 involved in the proposed transaction, first, second, . . . nth finance sources 130a-n, and an automated transaction assistant 158, all interconnected by a network 162.

The credit reporting agency 105 can be any entity, whether governmental or private, providing credit-related information for the user 120.

The search engine(s) 150 can be any type of search engine and is capable of collecting desired information, in real-time or near-real-time.

The vendor 154 can be any private or governmental entity providing a tangible or intangible good or service. Examples of vendors include service providers, suppliers, manufacturers, wholesalers, retailers, stores, websites, and the like.

The first, second, . . . nth finance sources 130a-n can be any private or governmental entity that provides credit or a debit service to the user 120. Examples include credit card issuers, debit card issuers, financial institutions such as banks, security brokers or dealers, money services businesses, telegraph companies, casinos, card clubs, vendors, and the like.

The automated transaction assistant 158 assists in a proposed business transaction between the user 120 and vendor 154 and is discussed in more detail below.

The network(s) 162 can be any wired or wireless, public or private, trusted or untrusted distributed processing network, including, for example, a local area network, wide area network (such as the World Wide Web), and/or a regional network, or combinations thereof. A common network(s) 162 uses the Transport Control Protocol (“TCP”) and/or Internet Protocol (“IP”).

### The Automated Transaction Assistant 158

The automated transaction assistant 158, in memory 134 (which can be any computer readable medium or media), includes one or more user profiles 110 corresponding to plural users or subscribers of the assistant 158, finance source data 132 associated with the various finance sources used by users or subscribers, one or more rule sets 166 defining assistant behavior, vendor data 170 associated with the various vendors used by users or subscribers, a search module 174 to receive user or subscriber input and structure searches to be performed by the search engine(s) 150, and a management module 178 to receive inputs and, based on the rule set(s) 166, manage assistant behavior. The assistant 158 further includes a microprocessor 182. The user profiles 110, finance source data 132, and vendor data 170 are typically in the form of databases.

The user profiles 110 correspond to users or subscribers of the automated transaction assistant 110. The user profiles 110 contain user-related information, including, without limitation, user identification, user residential addresses, user business name and addresses, user authentication information, electronic addresses of communication devices (e.g., any network (e.g., Internet) capable communication device, such as a personal computer, laptop, notebook computer, tablet computer, cellular phone, personal digital assistant, or other computerized device) associated with the user, user credit information, user financial information, user employment history, user Internet search history and results using the search module 174, user preferences, descriptions of user behavior such as vendor and/or product and/or service transaction history, description of user family members (and links to his or her user profile), and the like.

The finance source data 132 includes descriptions of finance sources used by users and/or subscribers, credit requirements and/or restrictions, transaction fees, credit and/or financial products, discount types and terms (e.g., rebate and/or transaction fee reduction, eligibility requirements for same, and duration of same), reward types and terms (e.g., reward description, eligibility requirements for same, and duration of same), and user transaction information (e.g., transaction dates, vendor identities, products purchased, product prices, state and federal taxes paid, transaction amount, amount of purchase price paid by each creditor, benefits realized by the user, coupons and other vendor benefits used by the user, and the like).

The rule sets 166 define behavior for the management module 178 in response to various inputs. For example, the rule sets 166 can describe how to compare competing benefits (e.g., rewards and/or discounts) of different cards in a specific transaction to determine the substantially optimal benefits for the user. They can describe how to structure a transaction to use, in the same transaction, different credit cards offering different benefits. The structure would, for instance, be to assign different portions of the purchase price to each credit card to substantially optimize user benefits. They can describe how to allocate a partial payment made by a user amongst plural credit card issuers (such as pay issuers in forward or reverse order of credit extension, proportionately based on outstanding credit to the user, and the like).

The vendor data 170 describes the various vendors used by users or subscribers. Vendor data 170 includes, for example, descriptions of vendor identification and locations, vendor federal and state tax information and requirements, vendor credit charge restrictions (e.g., the vendor will not pay credit card issuers more than X % in a given transaction), vendor credit offerings, benefits, and requirements, currently available vendor and/or manufacturer coupons or discounts on products and/or services of vendor, and the like.

The search module 174 receives user input and structures, in accordance with one or more rule sets 166, Internet searches for provision to search engine(s) 150, presents the search results to the user, and, in response to user input (e.g., product and/or service offering selections) works with the management module 178 to structure a transaction to purchase the selected product and/or service offerings on behalf of the user. The search module 174 can also, in response to requests by the management module 178, work with the search engine(s) 150, such as by interaction with finance sources and vendor web sites, to collect information to populate the finance source data 132 and vendor data 170.

The management module 176 supervises the overall operations of the assistant 158 and performs other services on behalf of the user. The management module 176 not only structures the user transaction to substantially optimize user benefits and handles distribution of user payments to plural credit card issuers but also collects input from the user to populate the user profiles 110, approves users to use the assistant 158, denies users the opportunity to use on a transaction basis or continue using altogether the assistant 158, determines, on a transaction basis and based on the products being purchased by the user, outstanding vendor and/or manufacturer coupons that may be used in the transaction, provides, on a transaction basis and for a fee, recommendations to the user on which cards to use to receive substantially optimal benefits (in transactions where the user does not wish to use a universal card), and provides, on a transaction basis and for a fee, recommendations to the user regarding credit cards that can be used to obtain greater benefits than are otherwise available with the existing credit cards of the user. The fee could, for example, be a percentage or otherwise related to the benefits received by the user through using the assistant 158.

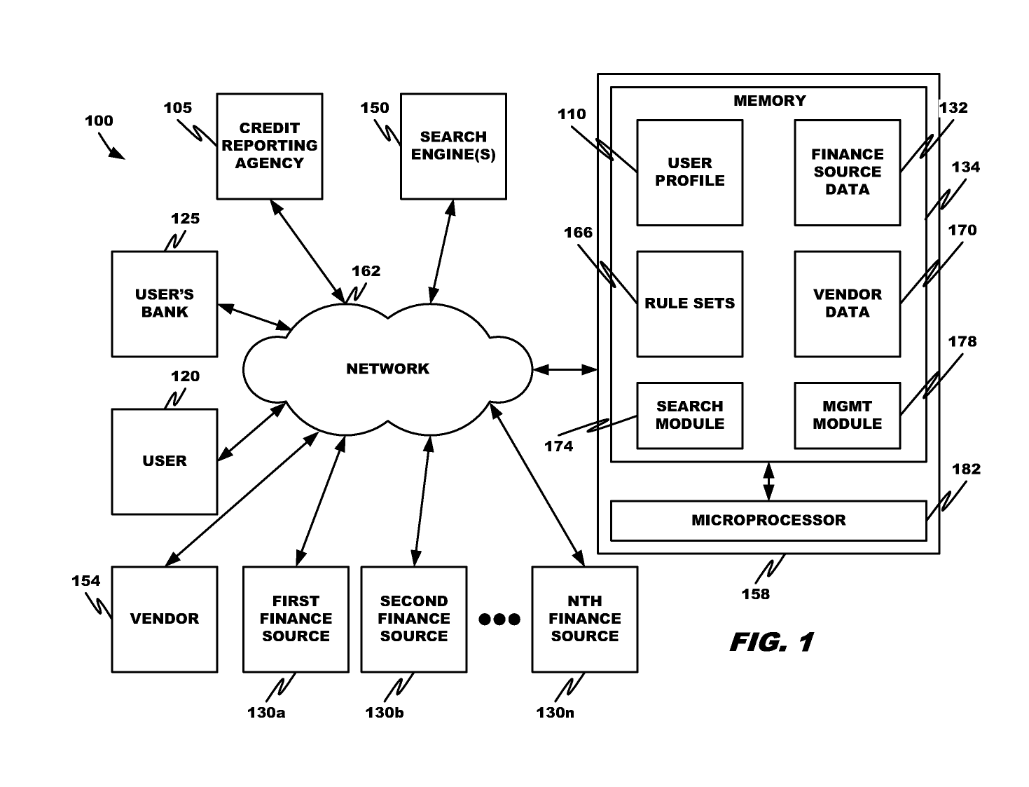

When a transaction system 100, such as that illustrated in FIG. 1, is set up for a particular user, the transaction assistant 158 accesses credit information from, for example, a credit reporting agency 105, such as TRW™. The credit information drawn from the credit reporting agency 105 may initially populate a user profile 110. The user profile 110 may reside on a web site, and the web site may be accessible by the user to make additions or modifications. As noted, the credit information includes a variety of information about finance sources available to the user (such as finance sources 130a, 130b . . . 130n, collectively 130), including, for example, the credit line amount, terms of payment, and interest rate. The types and amount of credit information are variable depending on the degree of complexity desired or useful in making the choice between finance sources 130.

The user profile 110 may optionally allow a user 120 to alter the credit information in the profile 110 and also to add additional credit information, such as promotional data, add additional sources of financing such as revolving credit lines, and any other credit information or finance sources that the user wishes the assistant 158 to consider in selecting between finance sources 130a-n. The user 120 will be told that, by placing the data on the web site, the user 120 is agreeing to allow the system to access the user's credit reports (from TRW™ for example), other sources of credit information, and finance sources. Using the authority granted by the user, the assistant 158 will be able to, for example, request and receive financing from the user's finance sources 130a-n, access contractual information about the provision of financing to the user from the user's finance sources 130a-n, and withdraw funds from the user's bank 125.

The user 120 can also use the profile 110 to input rewards programs, air miles for example, and set preferences to the programs. The preferences may be preset to defaults, but alterable by the user. For example, if the balance will be carried, then a user may determine that having the miles is worth two percentage points on the interest, as this is a subjective determination.

Credit information can also include user defined thresholds. For example, a user may never want to exceed ninety-percent credit capacity on any one credit card. Another example is in the case of a debit transaction. If a debit account balance is greater than a predefined threshold, then the assistant 158 may perform a direct withdrawal from that account. Otherwise, the assistant 158 would place the purchase in another debit account or a credit account.

Once the user profile 110 is populated, the universal card is ready for use. In one example system, once the user profile 110 is populated with credit information and, optionally, the user is satisfied with that information, the credit information is transported from the user profile 110 to the finance source data 132. If the user 120 decides to change his or her user credit information, the credit information optionally may be extracted from the finance source data 132 and used to populate the profile 110. The user 120 could then make the desired revisions, additions, or deletions and the revised credit information would then be saved back into the finance source data 132.

When the universal card is used by a user 120, the amount of the purchase is posted to the user's universal card account in the finance source data 132 by the management module 178. In some example systems, the management module 178 is also the portion of the system 100 that issued the universal card to the user based, for example, on an evaluation of the user's credit data in the user profile 110. The management module 178 then analyzes the user's credit information in the user profile 110 and determines which finance source 130 to use for the purchase. Generally, this is determined by looking at the interest rates and placing the purchase in the finance source with the lowest rate that has the capacity to absorb the purchase. Alternatively, much more complex schemes could be used. For example, the determination could factor in loyalty considerations (such as bonus points, airline miles, etc.), the type of financing being considered (e.g., debit versus credit, secured versus unsecured, etc.), the rate of increase or decrease of interest rates, performance of the stock market (instantaneous or trended), etc. The amount of the transaction could also be split between finance sources 130a-n, if the management module 178 so determines the necessity or advisability.

As rates change, a promotional rate expires for example, the management module 178 may automatically shift funds to a better rate, if one is available. For example, if a user has two credit cards, one with an introductory rate of 12 percent and an 18 percent rate after the introductory period, and another card with a rate of 16 percent, the management module 178 might move credit from the credit card with the introductory period to the other credit card after the introductory period expires, assuming all other factors being considered by the management module 178 are equal. Other factors that the management module 178 considers may make the move inadvisable.

The assistant 158 is automated in still other ways. For example, a finance source 130 may wish to offer financing to only those that meet certain criteria. In that case, once the criteria are met, a new finance source 130 could be automatically added to the universal card account and financing extended through that new source. An example of the foregoing would work as follows. A finance source may wish to extend credit only to those holders with a credit beacon score above a pre-determined threshold with an established history of carrying balances and having a balance level below a second threshold amount. A preferred credit line could be offered that has interest rates below any of those already offered to the user and balances from the higher rate sources automatically moved to the new preferred account.

All payments are made by the user to the universal card account and the monies are distributed by the management module 178 intelligently, again based upon interest rates, terms of payment, etc. The management module 178 would be knowledgeable about payment dates and would distribute the money close to the payment date. This could be done through automatic checking account deductions from the user's bank 125, or by billing the user one bill in advance of all of the credit card due dates. Payment can be made directly from the user's bank 125 or by mailing a check to the universal card issuer (typically, the entity that operates the assistant 158).

To augment the foregoing example of the preferred account, the universal card issuer may offer preferred payment terms to a preferred source to drive the interest rate down. Since the universal card issuer has control over distribution of funds, it could allocate all monies over the minimum card payments to the preferred source, thereby lowering the credit risk of the preferred source.

The universal card issuer could also hold some of the credit risk. It would simply need to beat the best deal that the user has from the other finance sources 130. In making a decision to hold some of the credit risk, the universal card issuer would have the benefit of knowing about the consumer's total credit and credit trends; knowing the consumer's payment history; knowing that it can redistribute the credit to other accounts if it gets nervous about the credit risk; and knowing that universal card issuer chooses the order that the finance sources will be repaid.

It will be understood that the various functions of the assistant 158 could be provided by a single computer or logic circuit or by multiple computers or logic circuits.

### Operations of the Automated Transaction Assistant 158

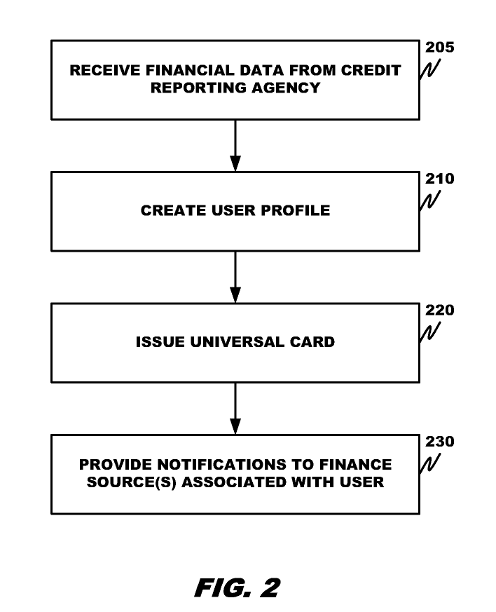

When a universal card account is first created, as illustrated in FIG. 2, the assistant 158 accepts finance data from, for example, a credit reporting agency (block 205). The assistant 158 then creates the user profile 110 including accepting additions, modifications, preferences, reward data, etc., from the user 120 to modify the finance data 132 for that user (block 210). That credit and other information is then used to populate a database. The data may then be analyzed to determine whether a universal card should be issued to that user and, if so, a universal card is issued to the user (block 220). Alternatively, the determination as to whether a universal card should be issued to that user might have been made manually or by another system. In some example systems, the determination of whether a universal card should be issued to a user and the actual issuance of the universal card to the user are accomplished before the user is granted access to the system. Finally, the assistant 158 will provide notifications to finance sources associated with the user and, if necessary, work out contractual and technical relationships with the user's finance sources (block 230). For example, the proprietors of the assistant 158 may need to enter into certain contracts with the user's finance sources 130 to make use of those finance sources on behalf of the user. Further, it may be necessary for the assistant 158 to have particular programming or data to communicate with the finance sources' systems. Again, these details could have been worked out manually or through another system. In some cases, it may be possible to work out contractual and technical details on a global basis. For example, it may be possible to work out such relationships with certain financial institutions that hold accounts for a large number of users. It may be necessary, however, to deal directly with some financial institutions for example because they have only a small number of potential users.

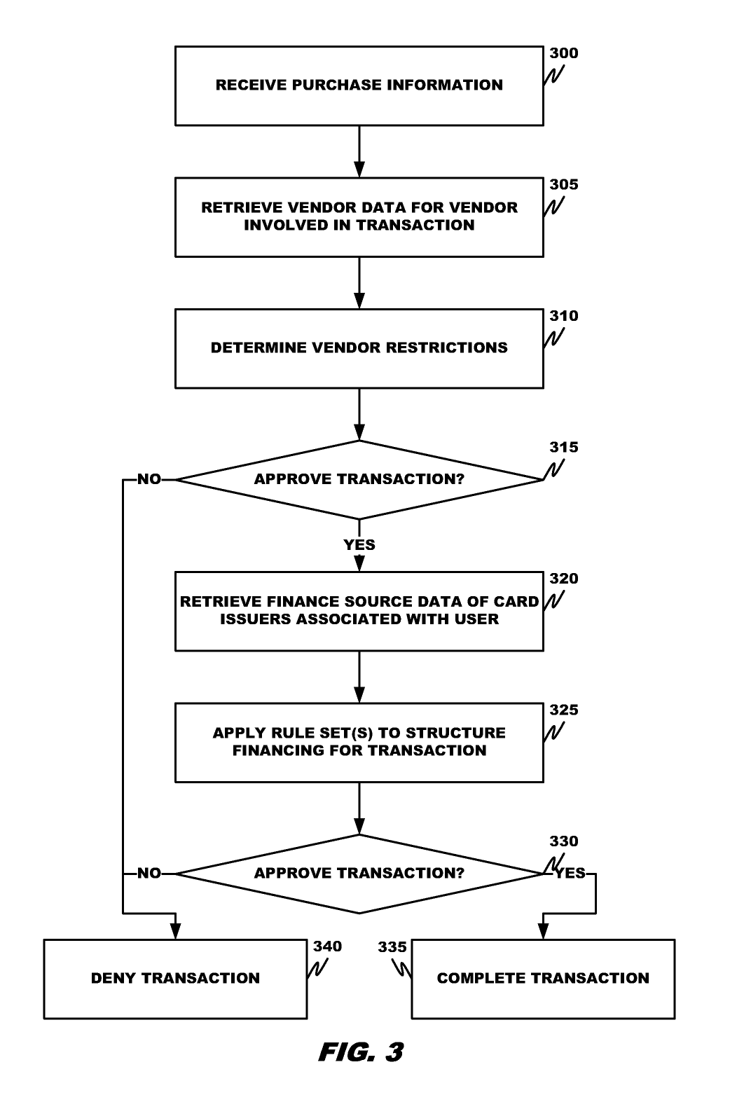

When processing a use of the universal card, as shown in FIG. 3, the assistant 158 receives purchase information through, for example, VISANET (block 300).

The assistant 158 retrieves vendor data 170 for the vendor involved in the transaction (block 305).

The assistant 158 then determines vendor restrictions on the transaction, including what transaction fees the vendor is willing to pay to card issuers for financing the transaction (block 310). As will be appreciated, credit card issuer transaction fees will flow through the universal card issuer to the vendor. The vendor may elect not to accept the transaction fees or may cap what transaction fees will be accepted in the transaction.

The assistant 158 then determines whether vendor restrictions will block the transaction from occurring (block 315).

When the transaction can be approved, the assistant 158 retrieves finance source data 132 of the card issuers associated with the user 120 (block 320).

The assistant 158 then applies the rule set(s) 166 to structure financing for the transaction (block 325). The proposed transaction must be in compliance with vendor restrictions, finance source restrictions, and user preferences and offer the user optimal benefits when compared to other possible transaction structures. Specifically, the assistant 158 reviews the finance data 132 associated with the user's finance sources 130 to determine the best source or sources to use for the purchase.

The assistant 158 then determines, from the finance source data 132 and rule set(s) 166, whether it is possible to approve the transaction (block 330). If it is not possible to structure a transaction using the user's existing finance sources 130, the transaction cannot be approved. Alternatively, user preferences or other input may prevent the proposed transaction structures from being acceptable to the user.

When the assistant 158 can approve the transaction, the transaction is completed (block 335) using the determined structure. This involves the assistant 158 interacting with the vendor to make payment arrangements with the vendor to complete the transaction in a manner similar to using a conventional credit card.

When the assistant 158 is unable to approve the transaction, the transaction is denied (block 340).

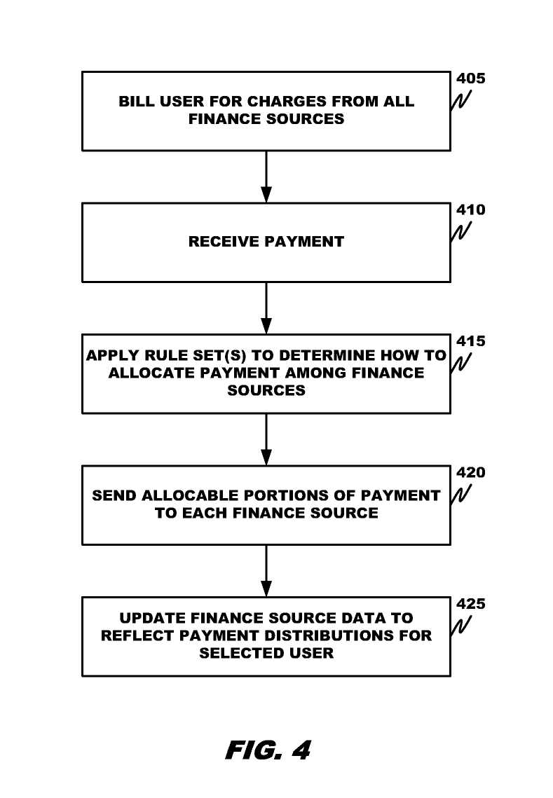

When processing payments associated with the use of the universal card, as shown in FIG. 4, the assistant 158 bills the user for all charges from all finance sources 130 (block 405). For example, if the assistant 158 were to receive notification from a first finance source 130a that it expects a minimum payment of $100 and from a second finance source 130b that it expects a minimum payment of $150, the assistant 158 can bill the user $250. The assistant 158 will then accept payment from the user (block 410), apply rule sets to determine how to allocate payment among finance sources 130a-n (block 415), and send allocable portions of payment to each of the finance sources (block 420), taking into account the credit data for the finance sources 130 being paid. For example, if a first finance source 130a requires payment before the 15th day of the month and a second finance source 130b requires payment before the 20th day of the month, the assistant 158 will pay the first finance source 130a as close to the 15th as possible and the second finance source 130b as close to the 20th as possible. In one example system, if the user makes a payment that is greater than the minimum payment required, the assistant 158 will allocate the excess payment to the finance source 130 that provides the greatest reward for such payments (or the smallest penalty for leaving a balance on a card). For example, in the example above if the user were to owe $500 on both credit card 1 and credit card 2 and the interest rate on credit card 1 is higher than credit card 2, the assistant 158 will make the minimum payment on credit card 1 and apply the remaining payment to credit card 2 in order to receive the lower interest rate for the remaining credit. In the event of a default by the user, partial payment is made in a fair manner, such as by allocating the payment on the fractional share each finance source 130 is owed the user as a result of use of the universal card. The assistant 158 then updates the user profile 110 and finance source data 132 to reflect the payment distribution for the user (block 425).

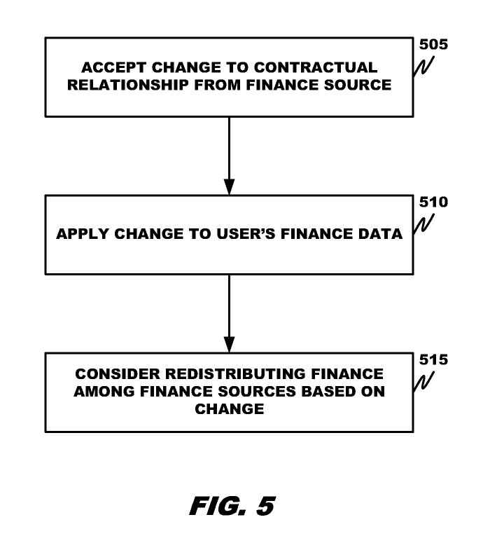

When processing changes in credit data made by finance sources 130, as shown in FIG. 5, the assistant 158 accepts a change from the finance source 130 (block 505) and applies the change to the user's credit data for that finance source (block 510). The assistant 158 then considers redistributing credit among the finance sources based on the change (block 515).

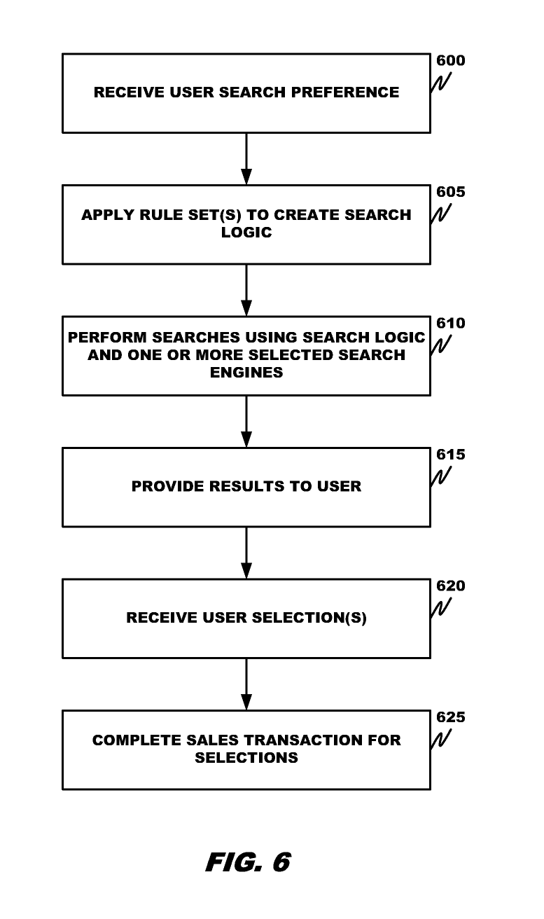

The assistant 158 can perform Internet searches for the user and automatically perform transactions on his or her behalf. Such transactions could include the purchase of automobiles, consumer electronics, or stocks. Referring to FIG. 6, the assistant 158 receives user search preferences (block 600).

In another embodiment, shown in FIG. 6, the assistant 158 is used to optimize transactions other than credit card purchases. The user then submits the search to the vendors in the profile through, for example, the Internet using the search module 174 and engine(s) 150, and is returned an ordered list of resources that match the profile criteria. In its simplest form, the user creates a search preference for a resource in a profile 110 through, for example, a web site. The profile 110 need not necessarily be pre-loaded, as was previously the case using the credit reporting agency 105. The exception is that if the user previously loaded the web site 110 with information, that information could be stored in a transaction database (not shown), and the profile 110 could be pre-loaded with the previous information retrieved from the transaction database. The profile 110 may contain, for example, the type of resource wanted (airline ticket, automobile, DVD player, stock), the max/min price limits that the user is willing to pay for the resource and typical vendors of the resource (airlines, hotels, GDS, stock exchanges, etc.).

The search module 174 applies the rule set(s) 166 to create a search logic (block 605), performs searches using the search logic and one or more selected search engines 150 (block 610), provides the results to the user 120 (block 615), receives the user selection(s) in the results (block 620), and completes the sales transaction based on the user selections (block 625).

The profile 110 can accept an abstract definition of the resource wanted, and the assistant 158 returns an ordered list of resources that fit within the abstract definition. For example, the profile may contain an abstract definition of a resource, such as “travel from New York City to Boston on May 1, 2006.” The assistant 158 may return a number of resources that would fit that abstract definition, such as flight schedules on one or more airlines, train schedules and rates, rental car rates, and so on.

In another example, the abstract resource definition may be “living accommodations in Dayton, Ohio for a two-year period beginning in May 2006 with the cost averaging $2000/month.” The assistant 158 may return a number of resources that would fit that abstract definition, such as home prices, apartment rental rates, hotel and motel prices, and so on. In circumstances such as this, the assistant 158 may also provide an analysis of suggested resources. Continuing with the example set out earlier in this paragraph, the assistant 158 may return an economic analysis of each of the resources, such as an analysis of the trend of housing costs, the cost of home maintenance, the cost of commuting from the locations of each of the suggested resources, and so on.

The search module 174 and engine(s) 150 need not be limited to the vendors listed in the profile 110 and/or vendor data 170, but can be adapted to translate the abstract definitions into directed Internet searches. For example, if the abstract definition is “travel from Boston to New York,” the search module 174 and engine(s) 150 can be adapted to translate that abstract definition into searches of general travel web sites, such as Travelocity and Expedia, etc., and vendor web pages, such as those for Continental Airlines, Hertz, etc. The search module 174 and engine(s) 150 may also be adapted to search for new web sites to include in such searches.

In addition, the search module 174 and engine(s) 150 can be adapted to prepare and produce the analysis of suggested resources.

The transaction assistant 158 can be used to provide a proposed transaction structure to the user 120 at the point of purchase, such as via a communication device of the user. The assistant 158 receives purchase information (e.g., total purchase price, identification(s) of product(s) to be purchased, vendor identity, and the like) through, for example, VISANET and/or by the user or vendor providing the purchase information to the assistant 158 (block 300). The assistant 158 retrieves vendor data 170 for the vendor involved in the transaction (block 305). The assistant 158 then determines vendor restrictions on the transaction, including what transaction fees the vendor is willing to pay to card issuers for financing the transaction (block 310). The assistant 158 next determines what, if any, coupon offerings are being offered on the identified products and/or on the transaction (block 700). The assistant 158 retrieves finance source data 132 of the card issuers associated with the user 120 (block 320). The assistant 158 then applies the rule set(s) 166 to structure financing for the transaction (block 325). Finally, the assistant 158 provides a proposed transaction structure to the user that is in compliance with vendor restrictions, finance source restrictions, and user preferences and offers the user optimal benefits when compared to other possible transaction structures (block 705).

To effect this service, all or part of the assistant 158 can be located on a communication device of the user or subscriber. Those local parts of the assistant 158 can be downloaded onto the communication device by any suitable technique, such as by an applet, a direct download (e.g., from an application store), a disk or other portable computer readable medium, and the like. A fee may be charged for each use of the service and/or for downloading the assistant application. This configuration has the advantage that sensitive customer information may be maintained in the communication device and not transmitted over the Internet. It further has the advantage that not as much sensitive customer information is required when compared to the prior assistant configurations.

The exemplary systems and methods of this disclosure have been described in relation to a distributed processing network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, the automated transaction assistant 158 can recommend a proposed transaction structure and only proceed if the user consents to the proposed structure. The user may request other factors to be considered in which event a new proposed structure is determined and presented to the user before completing the transaction.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
(a) receiving, by a microprocessor executable transaction assistant, purchase information reflecting a proposed purchase transaction by a user of a product offered by a vendor, the proposed purchase transaction including a monetary amount of the purchase transaction; and
(b) selecting, by the microprocessor executable transaction assistant and from among plural finance sources associated with the user, one or more finance sources to finance the purchase transaction.

2. The method of claim 1, wherein the microprocessor executable transaction assistant selects the one or more finance sources based on a comparison of user benefits offered by each of the plural finance sources if used to finance the purchase transaction and wherein the user benefits comprise one or more of discounts, rewards and credit terms.

3. The method of claim 1, wherein the microprocessor executable transaction assistant selects the one or more finance sources based on one or more vendor restrictions regarding transaction fees payable by the vendor to the one or more finance sources for financing the purchase transaction.

4. The method of claim 1, further comprising:
(c) initiating, by the transaction assistant, a financing-request transaction with the one or more selected finance sources on behalf of the user to obtain financing for the user to complete the purchase transaction.

5. The method of claim 1, further comprising:
receiving, by the transaction assistant, credit information regarding the user from a credit reporting agency;
populating, by the transaction assistant, a profile with the credit information; and
storing the credit information in a database.

6. The method of claim 4, wherein the transaction assistant initiates a financing-request transaction with multiple selected finance sources on behalf of the user to obtain financing for the user to complete multiple purchase transactions and further comprising:
billing, by the transaction assistant, the user for the multiple financed purchase transactions;
accepting, by the transaction assistant, payment from the user; and
providing, by the transaction assistant, payment to the multiple selected finance sources, with terms of the payment taking into account a role played by each of the multiple finance sources in the multiple financed purchase transactions.

7. A method for providing financing to a user from one or more finance sources, each finance source having financing data associated with that finance source, the method comprising:
(a) receiving purchase information reflecting a purchase transaction including a monetary amount of the purchase transaction;
(b) selecting one or more of the finance sources using at least a portion of the respective financing data to make the selection; and
(c) initiating a financing-request transaction with the one or more selected finance sources on behalf of the user to obtain financing for the user to complete the purchase transaction.

8. The method of claim 7, further comprising:
(d) receiving credit information regarding the user from a credit reporting agency;
(e) populating a profile with the credit information; and
(f) storing the credit information in a database.

9. The method of claim 8, further comprising:
(g) accepting modifications or additions to the credit information on the profile.

10. The method of claim 8, further comprising:
(g) accepting an assignment of a preference for one of the finance sources.

11. The method of claim 8, further comprising:
(g) accepting loyalty program data associated with one of the finance sources.

12. The method of claim 7, further comprising:
(d) accepting approval of the financing-request transaction from the one or more selected finance sources; and
(e) sending approval of the purchase transaction associated with the finance source.

13. The method of claim 7, further comprising:
(d) billing the user for the purchase transaction;
(e) accepting payment from the user; and
(f) sending payment to the one or more selected finance sources, with terms of the payment taking into account the financing data for the user's finance sources.

14. The method of claim 7, further comprising:
(d) receiving from one of the one or more finance sources a change in the financing data associated with the provision of financing by that finance source;
(e) adopting the change for use in selecting the one or more finance sources having, collectively, the financing data most advantageous to the user for the purchase transaction; and
(f) using the revised financing data to consider a redistribution of financing among the finance sources.

15. The method of claim 7, wherein initiating the financing-request transaction with the one or more selected finance sources on behalf of the user to request financing for the user to complete the purchase transaction comprises requesting financing for less than the monetary amount of the purchase transaction.

16. A system, comprising:
a microprocessor executable transaction assistant operable to:
receive purchase information reflecting a proposed purchase transaction by a user of a product offered by a vendor, the proposed purchase transaction including a monetary amount of the purchase transaction; and
select, from among plural finance sources associated with the user, one or more finance sources to finance the purchase transaction.

17. The system of claim 16, wherein the transaction assistant selects the one or more finance sources based on a comparison of user benefits offered by each of the plural finance sources if used to finance the purchase transaction and wherein the user benefits comprise one or more of discounts, rewards and credit terms.

18. The system of claim 16, wherein the transaction assistant selects the one or more finance sources based on one or more vendor restrictions regarding transaction fees payable by the vendor to the one or more finance sources for financing the purchase transaction.

19. The system of claim 16, wherein the transaction assistant is further operable to initiate a financing-request transaction with the one or more selected finance sources on behalf of the user to obtain financing for the user to complete the purchase transaction.

20. The system of claim 16, wherein the transaction assistant is further operable to:
receive credit information regarding the user from a credit reporting agency;
populate a profile with the credit information; and
store the credit information in a database.

21. The system of claim 19, wherein the transaction assistant initiates a financing-request transaction with multiple selected finance sources on behalf of the user to obtain financing for the user to complete multiple purchase transactions and wherein the transaction assistant is further operable to:
bill the user for the multiple financed purchase transactions;
accept payment from the user; and
provide payment to the multiple selected finance sources, with terms of the payment taking into account a role played by each of the multiple finance sources in the multiple financed purchase transactions.

22. A non-transient and tangible computer readable medium comprising a microprocessor executable computer program, the computer program including executable instructions that cause a computer to:
receive purchase information reflecting a proposed purchase transaction by a user of a product offered by a vendor, the proposed purchase transaction including a monetary amount of the purchase transaction; and
select, from among plural finance sources associated with the user, one or more finance sources to finance the purchase transaction.

23. The computer readable medium of claim 22, wherein the executable instructions, when executed, selects the one or more finance sources based on a comparison of user benefits offered by each of the plural finance sources if used to finance the purchase transaction and wherein the user benefits comprise one or more of discounts, rewards and credit terms.

24. The computer readable medium of claim 22, wherein the executable instructions, when executed, select the one or more finance sources based on one or more vendor restrictions regarding transaction fees payable by the vendor to the one or more finance sources for financing the purchase transaction.

25. The computer readable medium of claim 22, wherein the executable instructions, when executed, initiate a financing-request transaction with the one or more selected finance sources on behalf of the user to obtain financing for the user to complete the purchase transaction.

26. The computer readable medium of claim 22, wherein the executable instructions, when executed:
receive credit information regarding the user from a credit reporting agency;
populate a profile with the credit information; and
store the credit information in a database.

27. The computer readable medium of claim 25, wherein the executable instructions, when executed, initiate a financing-request transaction with multiple selected finance sources on behalf of the user to obtain financing for the user to complete multiple purchase transactions and wherein the executable instructions, when executed:
bill the user for the multiple financed purchase transactions;
accept payment from the user; and
provide payment to the multiple selected finance sources, with terms of the payment taking into account a role played by each of the multiple finance sources in the multiple financed purchase transactions.

28. A method for selecting a resource, comprising
receiving, by a microprocessor executable transaction assistant, an abstract definition of a resource;
converting, by the microprocessor executable transaction assistant, the abstract definition of the resource into one or more search requests that fall within the abstract definition;
running, by the microprocessor executable transaction assistant, the one or more search requests against a data repository to produce descriptions of resources; and
providing, by the microprocessor executable transaction assistant and to a user, the descriptions of resources.

29. The method of claim 28, wherein the data repository is the Internet.

30. The method of claim 28, further comprising:
providing an analysis of the described resources.

31. The method of claim 28, wherein, when converting the abstract definition of the resource into one or more search requests that fall within the abstract definition, the search requests are directed to one or more vendors listed in a profile.
